(19) United States
(12) Patent Application Publication
(10) Pub. No.: US 2006/0169011 A1
(43) Pub. Date: Aug. 3, 2006

(54) Blocking device for a motor vehicle steering shaft

(76) Inventor: Hans-Joachim Limburg, Schwabhausen (DE)

Correspondence Address: BACON & THOMAS, PLLC, 625 SLATERS LANE, FOURTH FLOOR, ALEXANDRIA, VA, 22314, US

(21) Appl. No.: 10/548,321

(22) PCT Filed: Apr. 21, 2004
(86) PCT No.: PCT/EP04/04218

§ 371 Date: Sep. 7, 2005

(30) Foreign Application Priority Data
May 6, 2003 (DE) 103 20 155.6

(51) Int. Cl. B60R 25/02

(52) U.S. Cl. 70/186

(57) ABSTRACT

A device for locking the steering shaft of a motor vehicle against rotation, includes a locking bolt cooperating with locking recesses of the steering shaft, which bolt is movable back and forth between a locking position and a release position by a control member that cooperates with a rotary position detector and is rotatable in two directions by an electric motor. The control member has a spiral rib or a spiral groove, which winds around the axis of rotation of the control member and cooperates with the rotary position detector in order to sense the rotary position of the control member corresponding to the release position of the locking bolt and the rotary position of the control member corresponding to the locking position of the locking bolt. A further detector is provided with which the locking bolt cooperates in order to sense the release position of the locking bolt.

The invention relates to a device for locking the steering shaft of a motor vehicle against rotation by a locking bolt which cooperates with locking recesses of the steering shaft and which is displaceable back and forth between a locking position and a release position with the aid of a control member that is rotatable back and forth by an electric motor and that cooperates with a rotary position detector.

Such devices for locking the steering shaft of a motor vehicle so that it can no longer be rotated are known in various forms.

In one such known device for locking the steering shaft of a motor vehicle against rotation, the control member has an eccentric that cooperates with the locking bolt urged into the steering shaft locking position by a helical compression spring, and the control member is connected in a manner fixed against relative rotation with the output gear wheel of a reduction gearing located downstream of the electric motor. The two rotary positions of the control member, associated respectively with the steering shaft locking position and the steering shaft release position of the locking bolt, are defined with the aid of two contactless switches or two microswitches with which the output gear wheel of the reduction gearing cooperates, and which are part of an electronic control circuit by means of which are controlled the electric motor, an alarm device that becomes operative in the event of improper motion of the locking bolt out of the locking positioning to the release position, and both the ignition and the starter of the motor vehicle engine (U.S. Pat. No. 4,643,009).

In another known device of this type for locking the steering shaft of a motor vehicle against rotation, the control member has a helically extending outer cam for moving the locking bolt, and the bolt extends parallel to the axis of rotation of the control member. Behind the end of the locking bolt facing away from the steering shaft the control member has peripheral teeth which are engaged by a worm mounted on the output shaft of the electric motor. Beside the peripheral teeth, on the side thereof facing the cam and the locking bolt, the control member cooperates with an electrical limit switch for stopping the control member after one revolution (German Patent Application DE-A 100 22 830).

In two other known devices of the general type described above for locking the steering shaft of a motor vehicle against rotation, the control member is provided with a helically extending inner or outer cam for moving the locking bolt disposed coaxially or parallel relative to the axis of rotation of the control member, and is also provided with peripheral teeth engaged by a worm mounted on the output shaft of the electric motor, or by an output gear of a spur gearing located downstream of the electric motor. In the one device, between the peripheral teeth and the other end of the control member electrical limit switches for detecting various rotary positions of the control member are distributed about the axis of rotation of the control member, which are actuated by means of corresponding cams on the control member. In the other device, between the peripheral teeth and the outer cam of the control member, electrical switch elements (snap switches and/or microswitches) for detecting various rotary positions of the control member are distributed about the axis of rotation of the control member, and are actuated by means of suitable cams on the control member. An electrical switch element (snap switch and/or microswitch) for detecting the steering shaft release position of the locking bolt is also provided which is actuated by means of a securing element moved by the control member and serving for securing the locking bolt when it is in the release position (German Patent Application DE-A 101 33 408).

Numerous other devices for locking the steering shaft of a motor vehicle against rotation by means of a locking bolt cooperating with locking recesses of the steering shaft are also known. The locking bolt can be displaced back and forth between a locking position and a release position with the aid of a control member that is rotatable back and forth by an electric motor, with the locking bolt cooperating with one or more detectors for sensing the locking bolt position. Three contactless switches (magnetic field sensors, in particular Hall sensors, or optical sensors) may be provided for sensing the release position or the locking position or a prelocking position of the locking bolt (German Patent DE-C 198 09 295). A Hall sensor may be provided for sensing the release position of the locking bolt (German Patents DE-C 199 06 267 and DE-C 199 24 835) or two Hall sensors may be provided for sensing the release position, or the locking position and the release position, of the locking bolt (German Patent DE-C 199 29 435), or an electrical switch may be provided for sensing the release position of the locking bolt (German Patents DE-C 101 09 609 and DE-C 101 21 714).

The object of the invention is to create a device of the type defined at the beginning which assures a secure determination of the steering shaft release position of the locking bolt while enabling both gentle and precise actuation of the rotary position detector, and to provide a compact structure which requires correspondingly little space.

This object is attained according to the invention by the features recited in the characterizing portion of claim 1. Advantageous improvements of the device of the invention are disclosed in the remaining claims.

One preferred embodiment of the device according to the invention for locking the steering shaft of a motor vehicle against rotation is described as an example below, in conjunction with drawings, wherein:

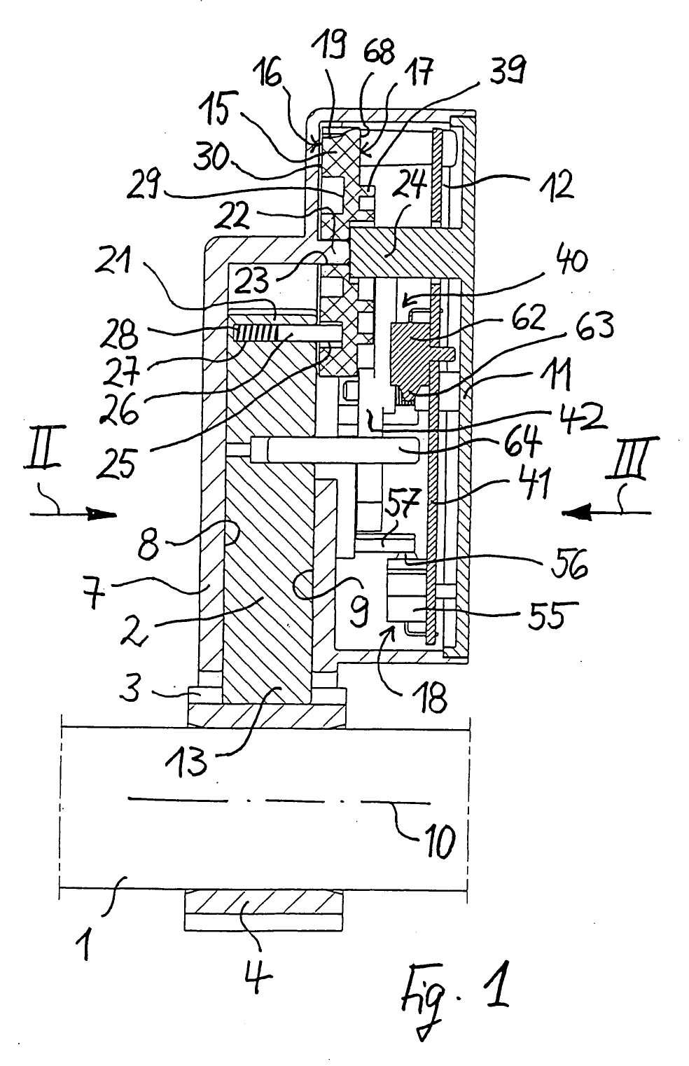

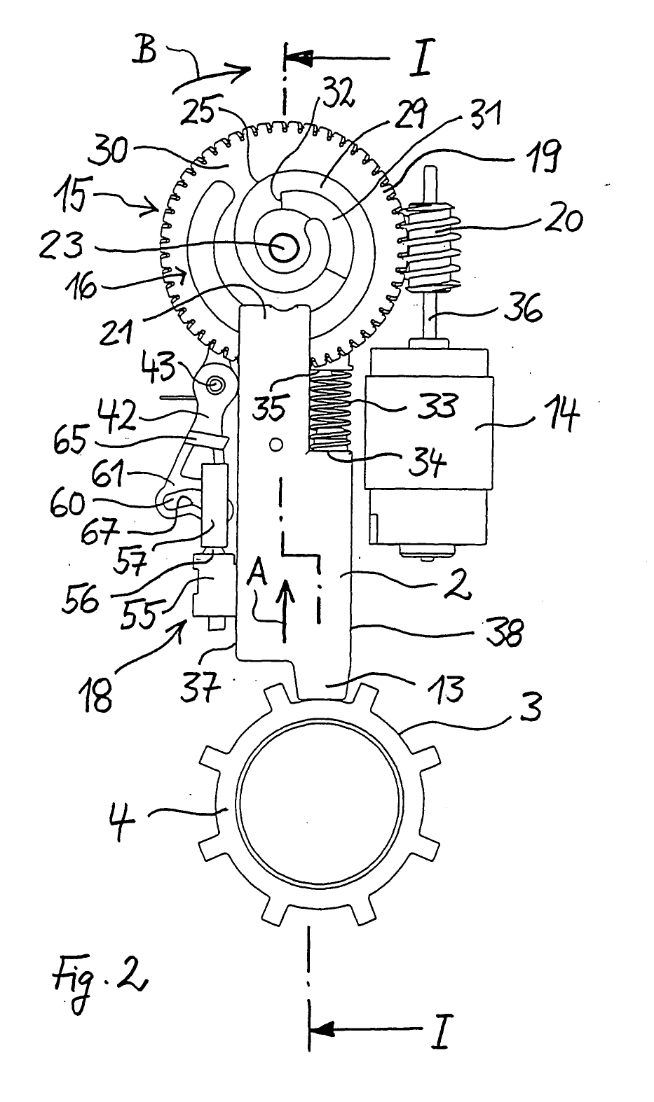

FIG. 1 is a longitudinal section taken along the line I-I in FIG. 2, wherein the locking bolt is in its locking position;

FIG. 2 is a view in the direction of the arrow II in FIG. 1, without the housing, housing cap, and printed circuit board and without the steering shaft;

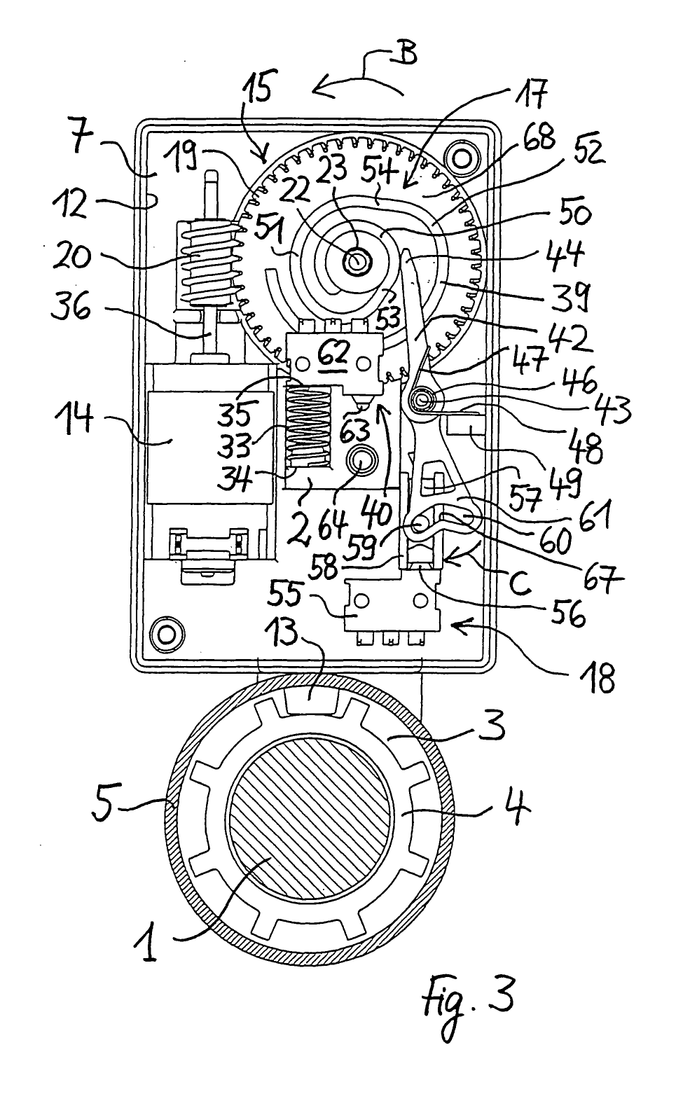

FIG. 3 is a view in the direction of the arrow III in FIG. 1, without the housing cap, and printed circuit board but with the tubular steering shaft housing;

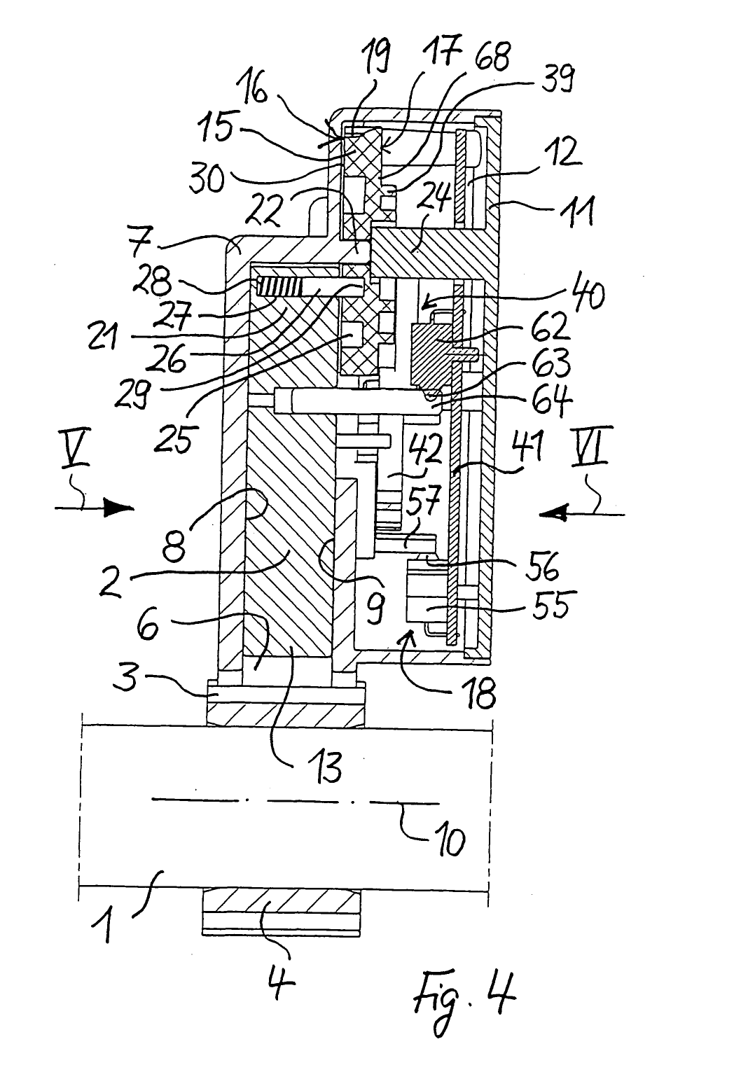

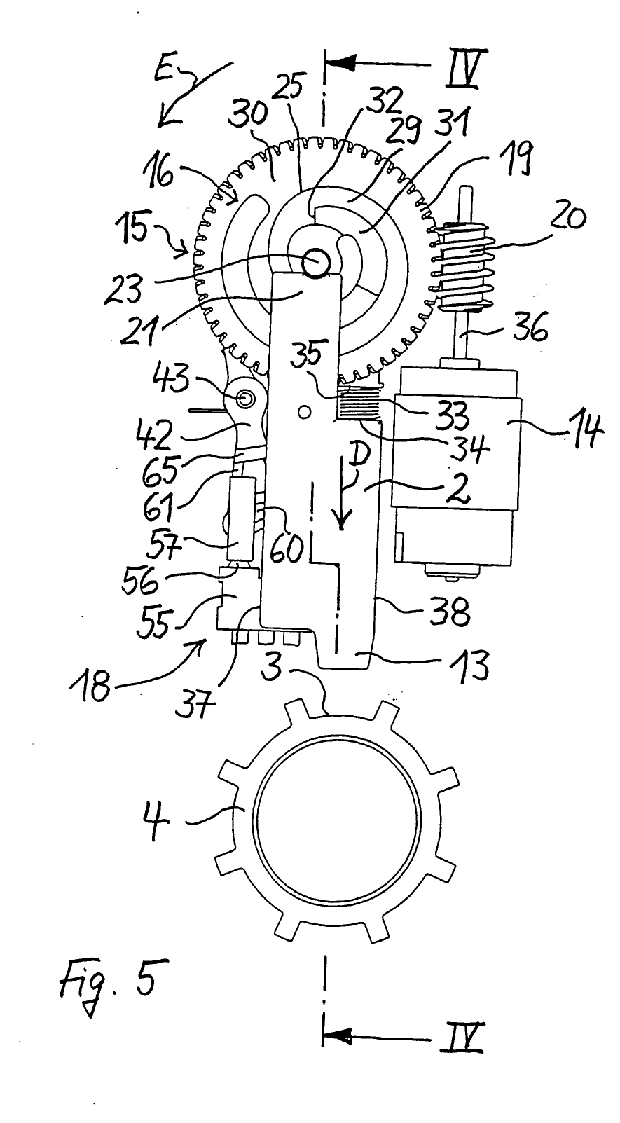

FIG. 4 is a longitudinal section taken along the line IV-IV in FIG. 5, wherein the locking bolt is in its release position;

FIG. 5 is a view in the direction of the arrow V in FIG. 4, without the housing, housing cap, and printed circuit board and without the steering shaft;

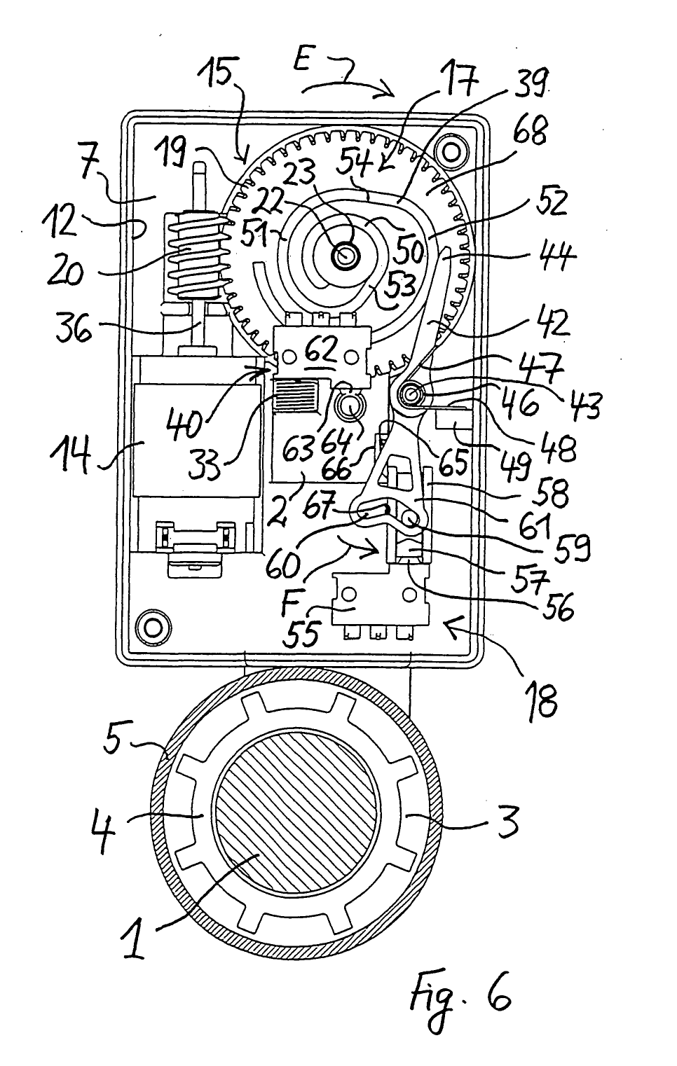

FIG. 6 is a view in the direction of the arrow VI in FIG. 4, without the housing cap, and printed circuit board but with the tubular steering shaft housing;

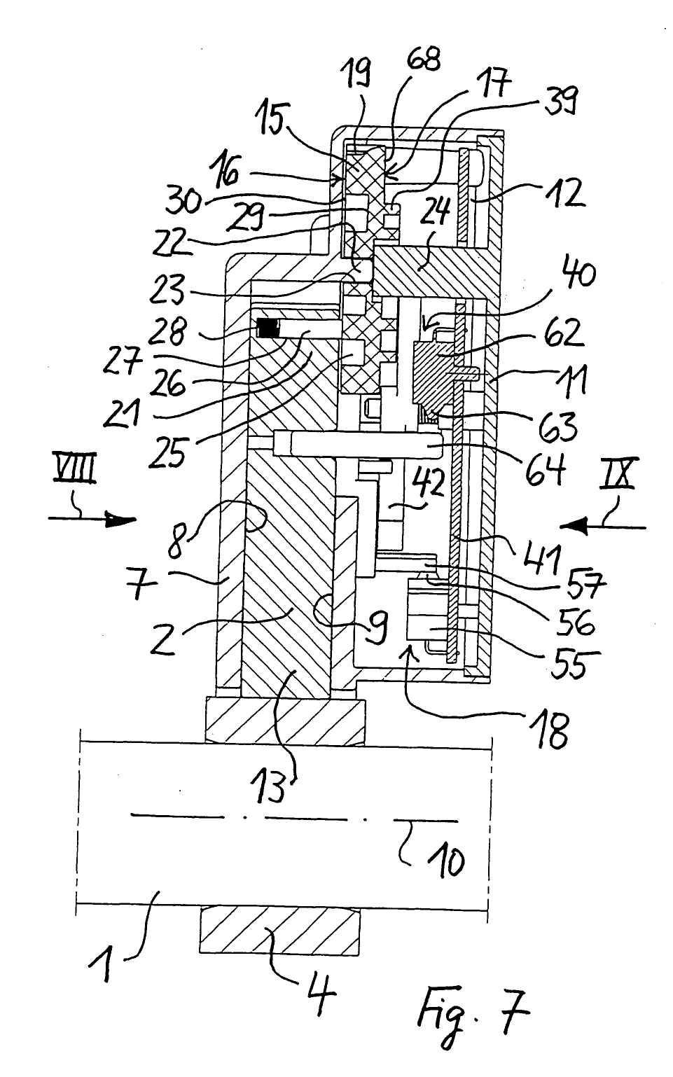

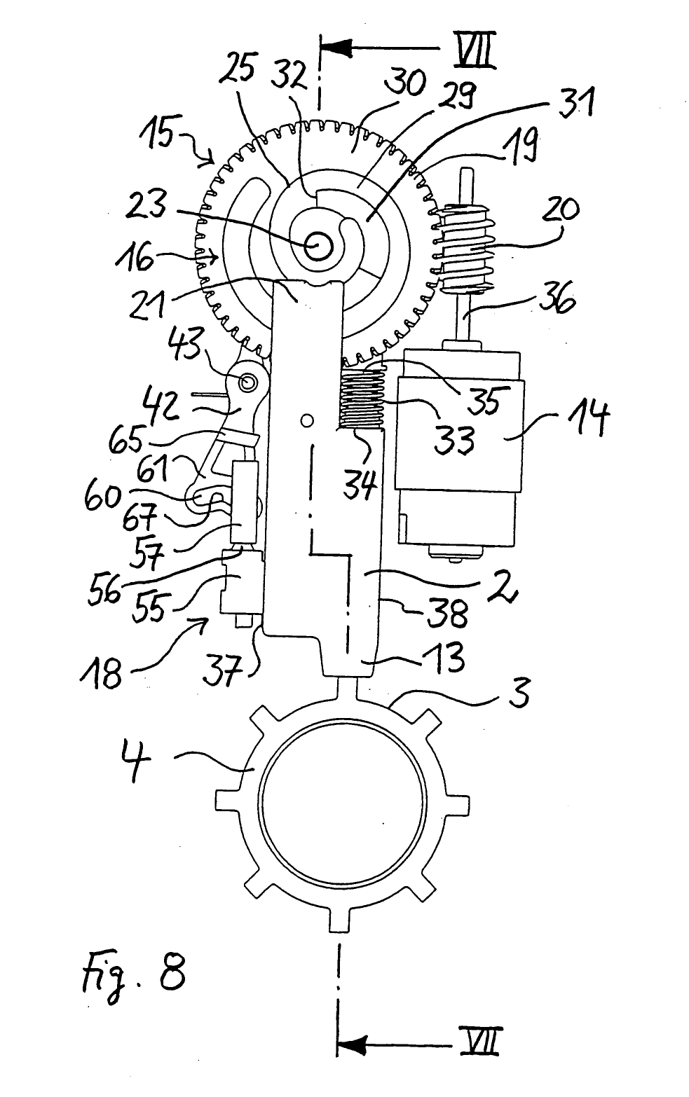

FIG. 7 is a longitudinal section taken along the line VII-VII in FIG. 8, wherein the locking bolt is in a prelocking position;

FIG. 8 is a view in the direction of the arrow VIII in FIG. 7, without the housing, housing cap, and printed circuit board and without the steering shaft;

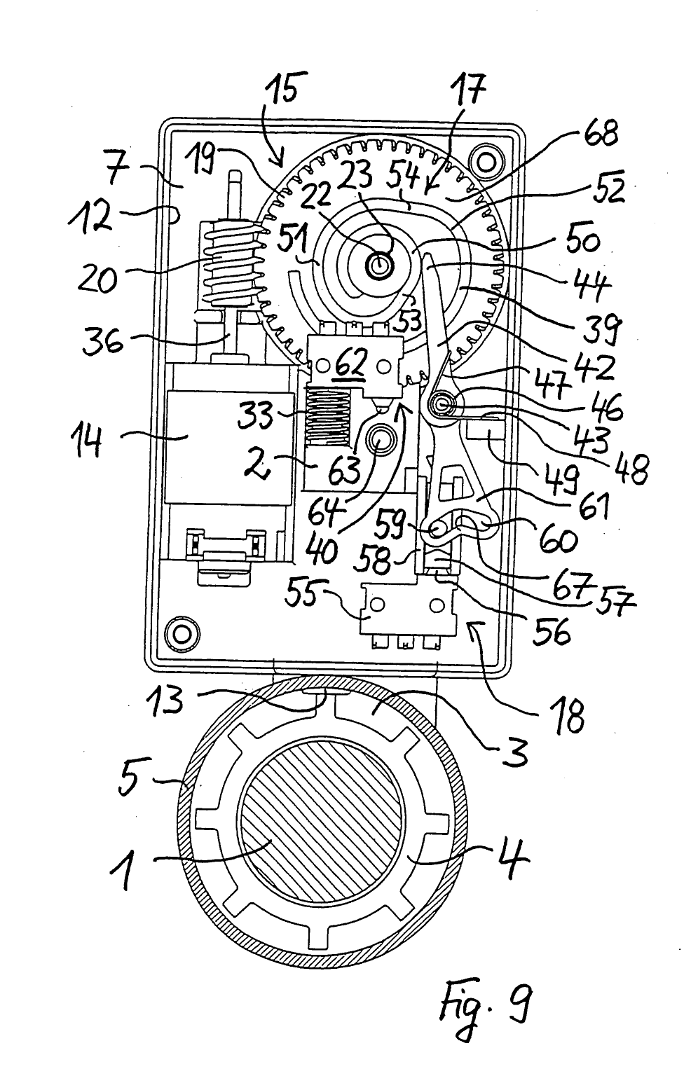

FIG. 9 is a view in the direction of the arrow IX in FIG. 7, without the housing cap, and printed circuit board but with the tubular steering shaft housing;

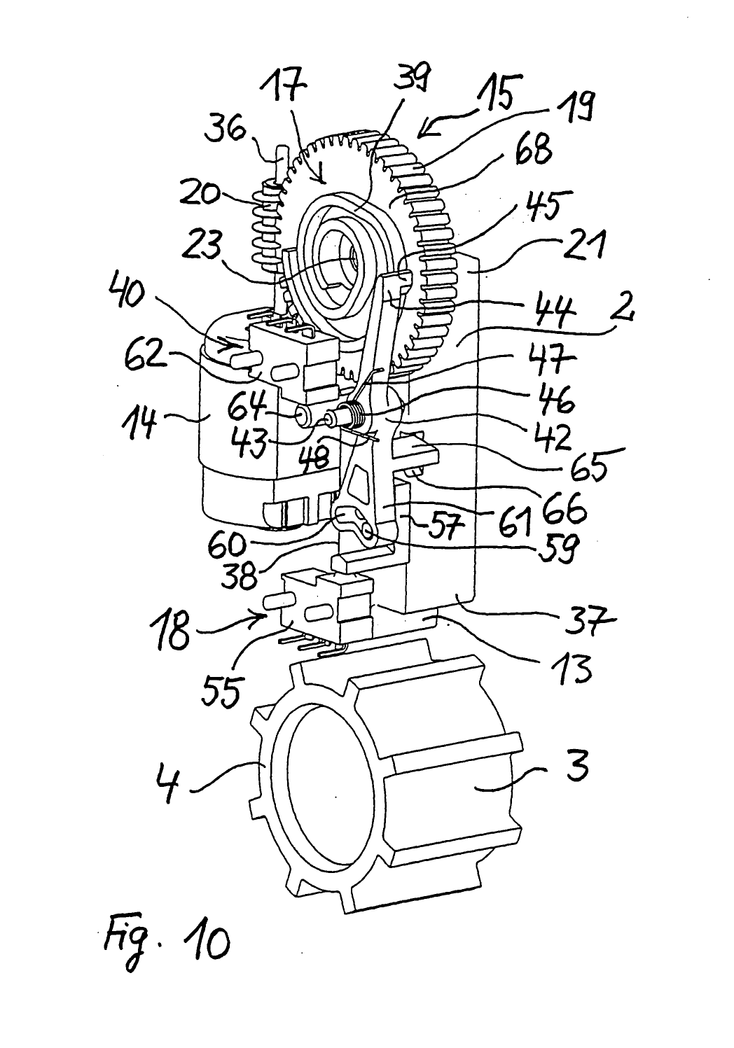

FIG. 10 is a view in the direction of the arrow VI in FIG. 4, without the housing, housing cap, and printed circuit board and without the steering shaft, shown in perspective;

FIG. 11 is a perspective view of the side of a control member provided with a spiral groove;

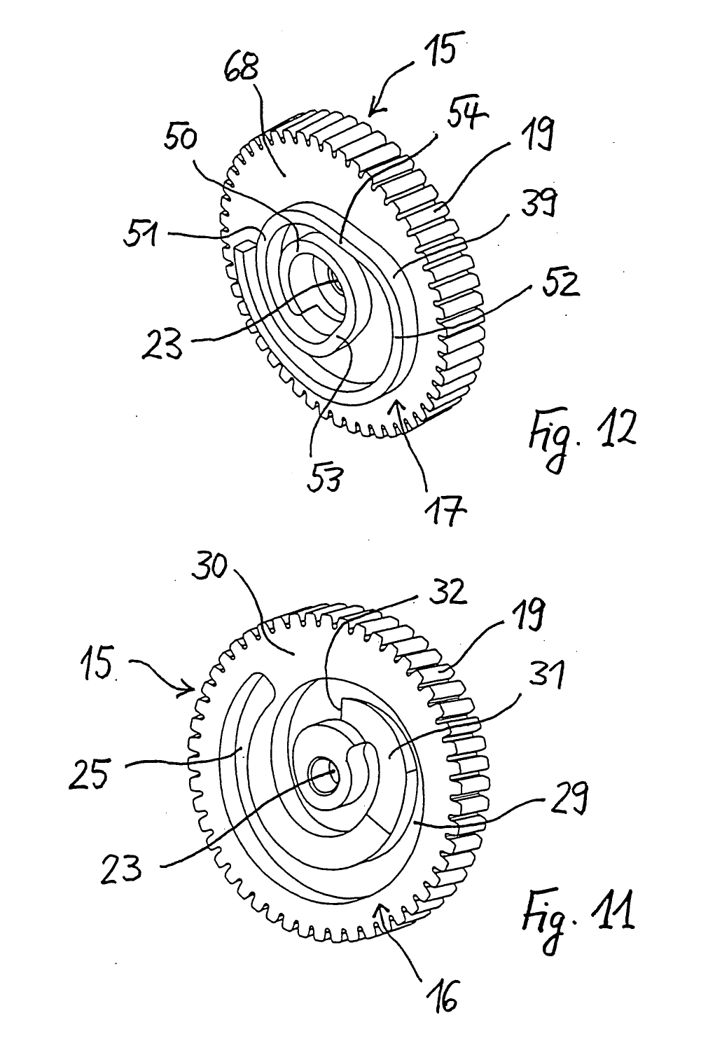

FIG. 12 is a perspective view of the side of a control member provided with a spiral rib.

The device shown for locking the steering shaft 1 of a motor vehicle against rotation includes a one-piece locking bolt 2 which cooperates with groovelike locking recesses 3 of a locking sleeve 4 secured to the steering shaft 1. The steering shaft 1 and the locking sleeve 4 are surrounded by a tubular housing 5, which has an aperture for the locking bolt 2.

The locking bolt 2 has a rectangular cross section and is supported axially displaceably in a bore 6 of corresponding cross section in a housing 7. The two broader side faces 8, 9 of the bore 6 each extend in a plane that extends perpendicular to the common longitudinal axis 10 of the steering shaft 1 and the tubular housing 5 coaxial with the steering shaft. On the side remote from the bore 6, the housing 7 is provided with a mounting opening 12 that is closed by a cap 11, and the housing 7 is secured to the tubular housing 5.

The locking bolt 2 is moveable back and forth between the locking position, shown in FIGS. 1, 2, and 3, at which, with its end 13 located toward the steering shaft 1, the bolt engages a locking recess 3 of the locking sleeve 4 so that the steering shaft 1 cannot be rotated, and a release position shown in FIGS. 4, 5, and 6, at which the end 13 of the locking bolt 2 does not engage any locking recess 3 of the locking sleeve 4 and releases the steering shaft 1 for rotation.

A control member 15 which can be rotated to-and-fro by an electric motor 14, the direction of rotation of which can be reversed, is used for axially displacing the locking bolt 2 into the release position and in the opposite direction into the locking position, the control member 15 being configured as a circular disk which cooperates on one side 16 with the locking bolt 2 and on the other side 17 with a rotary position detector 18 and which has peripheral teeth 19 engaged by a worm 20 driven by the electric motor 14.

On the side of the locking bolt 2 facing the housing cap 11, the control member 15 is disposed next to the end 21 of the locking bolt 2 that is remote from the steering shaft 1, and is rotatably supported in the housing 7 on a cylindrical protrusion 22 of the housing 7 that engages a central bearing bore 23 of the control member 15 and extends perpendicular to the two broader side faces 8, 9 of the bore 6 of the housing 7 that guides the locking bolt 2. The control member 15 is axially held on the cylindrical protrusion 22 by means of a cylindrical protrusion 24 of the housing cap 11 that has a diameter larger than the diameter of the cylindrical protrusion 22.

On the side 16 adjacent to the locking bolt 2, the control member 15 is provided with a spiral groove 25, which winds around the bearing bore 23 of the control member 15 and is engaged by a pin 26 that protrudes laterally from the locking bolt 2, so that the locking bolt 2, upon rotation of the control member 15 in one direction or the other, is axially displaced in one direction or the other, respectively, radially relative to the axis of rotation of the control member 15 that is defined by the housing protrusion 22.

The cylindrical pin 26 is supported axially displaceably in a cylindrical bore 27, provided in the end 21 of the locking bolt 2 remote from the steering shaft, and is urged in the direction towards the control member 15 by a helical compression spring 28 disposed in the bore 27. The control member 15 has an inclined face 31 cooperating with the pin 26, as will be described hereinafter, and rising from the bottom 29 of the spiral groove 25 to the flat surface 30 of the control member 15 facing the locking bolt 2, this inclined face extending along the spiral groove 25 beginning at a point 32, described hereinafter, of the bottom 29 of the spiral groove 25. The locking bolt 2 is urged in the direction towards the steering shaft 1 by a helical compression spring 33 which is retained on one end against a shoulder 34 of the locking bolt 2 and on the other end against a shoulder 35 of the housing 7.

The worm 20 that engages the peripheral teeth 19 of the control member 15 is secured to the output shaft 36 of the electric motor 14. The electric motor 14 is disposed next to the locking bolt 2 in the housing 7 so that its output shaft 36 extends parallel to the two narrower side faces 37, 38 of the locking bolt 2.

On the side 17 remote from the locking bolt 2, the control member 15 is provided with a protruding spiral rib 39 which winds around the bearing bore 23 of the control member 15 and cooperates with the rotary position detector 18 in order to sense the rotary position of the control member 15 corresponding to the release position of the locking bolt 2 and the rotary position of the control member 15 corresponding to the locking position of the locking bolt 2. A further detector 40 is provided, with which the locking bolt 2 cooperates, for sensing the locking bolt release position. The rotary position detector 18, like the further detector 40, is disposed on a printed circuit board 41 that is secured in the housing 7 and extends parallel to the housing cap 11.

The spiral rib 39 of the control member 15 cooperates with the rotary position detector 18 via a two-armed pivot lever 42. The pivot lever 42 is pivotably supported in the housing 7 about an axis 43 that extends parallel to the housing protrusion 22. On its end 44 adjacent to the control member 15, the pivot lever has a protrusion 45, extending parallel to the pivot axis 43 with which the spiral rib 39 of the control member 15 cooperates, and the pivot lever is biased by a helical torsion spring 46 so that the protrusion 45 rests against the spiral rib 39. The helical torsion spring 46 is disposed on the pivot axis 43 of the pivot lever 42 and is supported by one leg 47 on the pivot lever 42 and by the other leg 48 on a protrusion 49 of the housing 7.

The spiral rib 39 of the control member 15 extends over an angle of rotation of the control member 15 of over 360° and has three circular-segment portions 50, 51, 52, concentric with the bearing bore 23 of the control member 15 and having different radii of curvature, and two substantially straight portions 53, 54. The two straight portions 53, 54 serve to pivot the pivot lever 42. One straight portion 53 connects the circular-segment portion 50, which has the shortest radius of curvature, to the circular-segment portion 51 which has a middle-sized radius of curvature. The other straight portion 54 connects the circular-segment portion 51 that has a middle-sized radius of curvature to the circular-segment portion 52 that has the longest radius of curvature.

The rotary position detector 18 includes an electrical resetting switch 55 having an actuation element 56. The pivot lever 42 cooperates with the actuation element 56 via an L-shaped slide 57 which is movable in a U-shaped guide 58 on the housing 7 in the same direction as the actuation element 56 of the resetting switch 55. The slide 57 is provided with a cylindrical protrusion 59 which extends parallel to the pivot axis 43 of the pivot lever 42 and engages a transverse slot 60 formed as an inverted shallow V that is provided in the end 61 of the pivot lever 42 remote from the spiral rib 39 of the control member 15.

The further detector 40 is likewise formed by an electrical resetting switch 62 having an actuation element 63. The actuation element 63 is movable in the same direction as the locking bolt 2. A pinlike lateral protrusion 64 of the locking bolt 2 cooperates with the actuation element 63.

The pivot lever 42, between its pivot axis 43 and its end 61 remote from the spiral rib 39 of the control member 15, is provided with a platelike further protrusion 65 which extends parallel to the pivot axis 43 and serves to secure the locking bolt 2 in its release position. As seen particularly clearly in FIG. 10, the protrusion 65 of the pivot lever 42 then engages a lateral recess 66 in the locking bolt 2, so that the locking bolt 2 is locked in the release position.

The device described for locking the steering shaft 1 against rotation functions as follows:

To displace the locking bolt 2 axially out of the locking position of FIGS. 1, 2 and 3 in the direction of the arrow A (FIG. 2) into the release position of FIGS. 4, 5 and 6, the electric motor 14 is switched on so that its output shaft 36, via the worm 20, rotates the control member 15 in the direction of the arrow B (FIGS. 2, 3), and the pin 26 of the locking bolt 2 in the spiral groove 25 of the control member 15 moves closer and closer to the axis of rotation 22 and to the bearing bore 23 of the control member 15. Simultaneously, the spiral rib 39 of the control member 15 pivots the pivot lever 42 out of the position shown in FIG. 3 in the direction of the arrow C into the position shown in FIG. 6, specifically by the inner straight portion 53 initially out of the position of FIG. 3 into the middle position, where the protrusion 59 of the slide 57 is located on the middle apex point 67 of the transverse slot 60 of the pivot lever 42 in order to switch off the electrical resetting switch 55, and after that by the outer straight portion 54 out of the middle position into the position of FIG. 6 in order to switch the electrical resetting switch 55 back on again and to cause the protrusion 65 of the pivot lever 42 to enter the recess 66 of the locking bolt 2 so that the locking bolt 2 is secured in its release position. On reaching the release position, the locking bolt 2, with its protrusion 64 engages the actuation element 63 of the further electrical resetting switch 62 and the locking bolt 2 switches the resetting switch 62 on.

In order to displace the locking bolt 2 axially out of the release position of FIGS. 4, 5 and 6 in the direction of the arrow D (FIG. 5) into the locking position of FIGS. 1, 2 and 3, the electric motor 14 is switched on, so that its output shaft 36, via the worm 20, rotates the control member 15 in the direction of the arrow E (FIGS. 5, 6), and the pin 26 of the locking bolt 2 in the spiral groove 25 of the control member 15 moves farther and farther away from the axis of rotation 22 and the bearing bore 23 of the control member 15. Simultaneously, the spiral rib 39 of the control member 15 pivots the pivot lever 42 out of the position in FIG. 6 in the direction of the arrow F into the position in FIG. 3, specifically first by the outer straight portion 54 out of the position in FIG. 6 into the middle position, at which the protrusion 59 of the slide 57 is located at the middle apex point 67 of the transverse slot 60 of the pivot lever 42, in order to remove the protrusion 65 of the pivot lever 42 from the recess 66 of the locking bolt 2 and to release the locking bolt 2, and to switch off the electrical resetting switch 55. After that, the inner straight portion 53 pivots the pivot lever 42 out of the middle position into the position of FIG. 3 in order to switch the electrical resetting switch 55 back on again. When the locking bolt 2 leaves the release position, and its protrusion 64 releases the actuation element 63 of the further electrical resetting switch 62, the resetting switch 62 is switched off again.

Upon rotation of the control member 15 in the direction of the arrow E, with no locking recess 3 of the steering shaft 1 or of the locking sleeve 4 being located opposite the one-piece locking bolt 2 or its end 13 extending toward the steering shaft, the locking bolt 2 or its end 13 cannot enter into a locking recess 3, and the locking bolt 2 cannot move into its locking position, but only into the prelocking position of FIGS. 7, 8 and 9. As soon as the locking bolt 2, axially displaced in the direction of the arrow D, reaches this prelocking position, the pin 26 of the locking bolt 2 rests with its free end on the point 32 of the bottom 29 of the spiral groove 25 of the control member 15. Upon further rotation of the control member 15 in the direction of the arrow E, the pin 26 slides with its free end on the inclined face 31 of the control member 15 onto the flat surface 30 of the control member 15, which surface is oriented toward the locking bolt 2 so the pin 26 is caused to return into the bore 27 of the locking bolt 2 against the action of the helical compression spring 28, and to leave the spiral groove 25 of the control member 15 so that the control member 15 can be rotated onward in the direction of the arrow E until it is in the position corresponding to the locking position of the locking bolt 2, as shown in FIGS. 7, 8 and 9.

From the prelocking position of FIGS. 7, 8 and 9, under the influence of its helical compression spring 33, the one-piece locking bolt 2 readily reaches the locking position of FIGS. 1 through 3 when the steering shaft 1, with the locking sleeve 4, is rotated out of the position of FIGS. 7, 8 and 9 into the position of FIGS. 1, 2 and 3, at which a locking recess 3 of the locking sleeve 4 is aligned with the adjacent end 13 of the locking bolt 2. In that, the pin 26 of the locking bolt 2 slides with its free end on the level surface 30 of the control member 15 and finally is pushed forward by its helical compression spring 28 back out of the bore 27 of the locking bolt 2 into engagement with the spiral groove 25 of the control member 15.

The two electrical resetting switches 55, 62 are connected to an electric or electronic control circuit for controlling for example, the electric motor 14, an optical and/or acoustical alarm device that becomes operative upon improper motion of the locking bolt 2 out of the locking position into the release position and/or improper motion of the locking bolt 2 out of the release position into the locking position, the ignition and/or the starter of the engine of the motor vehicle provided with the device for locking the steering shaft 1 against rotation, etc.

In the described device for locking the steering shaft 1 against rotation, the release position of the locking bolt 2 is sensed redundantly and hence securely by the rotary position detector 18 and the further detector 40. The rotary position detector 18 and the further detector 40 or the two electrical resetting switches 55, 62 are actuated very gently, namely precisely in the direction in which the respective actuation element 56 or 63 is movable, which correspondingly lengthens the service life. The actuation of the rotary position detector 18 or of the electrical resetting switch 55 is done very precisely in the respective rotary position of the control member 15, namely within a very narrow rotary position fluctuation range, with the aid of the spiral rib 39 or the two straight portions 53, 54 of the spiral rib 39, which are oriented so that they-bring about a relatively long travel distance of the pivot lever 42 over a relatively small angle of rotation of the control member 15. The device is distinguished by an extraordinarily compact structure, requiring correspondingly little space.

The disklike control member 15 visible particularly clearly in FIGS. 11 and 12, with the peripheral teeth 19 and the two plane surfaces 30, 68, extending parallel to each other on either side of the peripheral teeth 19, namely on the side 16 of the control member 15 provided with the recessed spiral groove 25 and on the side 17 of the control member 15 provided with the protruding spiral rib 39, is relatively thin and therefore allows an especially compact configuration of the device for locking the steering shaft 1 against rotation of FIGS. 1 through 10 and requiring correspondingly little space. The spacing between the printed circuit board 41 and the locking bolt 2 may be very slight, and the housing 7 can be kept correspondingly slender.

Furthermore, the control member 15 makes it possible to locate the electric motor 14 next to the locking bolt 2, so that the output shaft 36 of the electric motor with the worm 20 engaging the peripheral teeth 19 of the control member 15 extends parallel to the locking bolt 2, which is also advantageous with respect to obtaining the smallest possible dimensions of the housing 7 and thus of the device for locking the steering shaft 1 against rotation as shown in FIGS. 1 through 10.

Modifications of the embodiment shown and described are certainly possible. For instance, the control member 15 need not necessarily be driven with the aid of the worm 20; instead, a pinion driven by the electric motor 14 may engage correspondingly configured peripheral teeth 19 of the control member 15. Also, instead of the protruding spiral rib 39, the control member 15 may have a spiral groove cooperating with the rotary position detector 18. Instead of electrical resetting switches, in particular microswitches, the rotary position detector 18 and the further detector 40 may comprise nonresetting or contactless switches (magnetic field sensors, in particular Hall sensors, photosensors, etc.).

1. In a device for locking the steering shaft of a motor vehicle against rotation, including a locking bolt which cooperates with locking recesses of the steering shaft and which is displaceable back and forth between a locking position and a release position by means of a control member that is rotatable back and forth about an axis of rotation by an electric motor and that cooperates with a rotary position detector, the improvement comprising:
a spiral rib or a spiral groove which winds around the axis of rotation of the control member and cooperates with the rotary position detector to sense the rotary position of the control member corresponding to the release position of the locking bolt and the rotary position of the control member corresponding to the locking position of the locking bolt; and
a detector with which the locking bolt cooperates that is arranged to sense the release position of the locking bolt.

2. The improvement according to claim 1, wherein the spiral rib or spiral groove of the control member extends over a control member angle of rotation of at least 360°.

3. The improvement according to claim 1, wherein the spiral rib or spiral groove of the control member cooperates with the rotary position detector via a two-armed pivot lever, the pivot axis of which extends parallel to the axis of rotation of the control member.

4. The improvement according to claim 1, wherein the spiral rib or spiral groove of the control member extends over a control member angle of rotation of at least 360°:
wherein the spiral rib or spiral groove of the control member cooperates with the rotary position detector via a two-armed pivot lever, the pivot axis of which extends parallel to the axis of rotation of the control member;
wherein the spiral rib or spiral groove of the control member has three circular-segment portions, extending concentrically with the axis of rotation of the control member, and having different radii of curvature, and two substantially straight portions for pivoting the pivot lever, and which connect to each other the circular-segment portion having the shortest radius of curvature and the circular-segment portion having the middle-sized radius of curvature, and connect to each other the circular-segment portion having the middle-sized radius of curvature and the circular-segment portion having the longest radius of curvature.

5. The improvement according to claim 3, wherein, the rotary position detector is an electrical resetting switch having an actuation element with which the pivot lever cooperates via a slide which is movable in the same direction as the actuation element of the resetting switch.

6. The improvement according to claim 5, wherein the slide has a cylindrical protrusion which extends parallel to the pivot axis of the pivot lever and which engages a transverse slot on the end of the pivot lever remote from the spiral rib or spiral groove of the control member.

7. The improvement according to claim 3, wherein the pivot lever has a protrusion on its end adjacent to the control member which extends parallel to its pivot axis and with which the spiral rib or spiral groove of the control member cooperates.

8. The improvement according to claim 7, wherein the pivot lever is spring-biased so as to urge the protrusion to contact the spiral rib of the control member.

9. The improvement according to claim 3, wherein the pivot lever is provided with a protrusion which extends parallel to its pivot axis and which engages a lateral recess in the locking bolt for securing the locking bolt in its release position, the bolt being moveable back and forth radially relative to the axis of rotation of the control member.

10. The improvement device according to claim 1, wherein the further detector comprises an electrical resetting switch having an actuation element which is movable in the same direction as the locking bolt and with which a lateral protrusion of the locking bolt cooperates.

11. The improvement according to claim 1, wherein the control member is configured as a circular disk with peripheral teeth engaged by a worm or pinion driven by the electric motor.

12. The improvement according to claim 11, wherein the spiral rib or spiral groove of the control member is disposed on the side of the control member facing away from the locking bolt which is moveable back and forth radially relative to the axis of rotation of the control member.

13. The improvement according to claim 12, wherein the control member is disposed between the locking bolt and a printed circuit board on which the rotary position detector and the further detector are mounted.
